(19) United States
(12) Patent Application Publication
(10) Pub. No.: US 2009/0118902 A1
(43) Pub. Date: May 7, 2009

(54) Operating Method and Operating System for a Vehicle

(75) Inventors: Metta Boger, Aidlingen (DE); Tanja Schilling, Tuebingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/994,087

(22) PCT Filed: Jun. 28, 2006
(86) PCT No.: PCT/EP2006/006243

§ 371 Date: Jun. 4, 2008

(30) Foreign Application Priority Data
Jun. 29, 2005 (DE) 10 2005 030 181.9

(51) Int. Cl. B60K 37/06; G06F 17/00; G06F 3/048

(52) U.S. Cl. 701/36; 700/94; 715/771; 715/810

(57) ABSTRACT

An operator control method for a vehicle having at least one switch which, when operated, activates an associated application or application group, where a stored last state or a prescribed basic state for the associated application or application group is set and is shown on a screen display, and to an associated operator control system. The identified operation of the switch is followed by activation of the associated application or application group, and setting a stored menu state for the purpose of operator control when the associated application or application group has been deactivated.

This application is a national stage of PCT International Application No. PCT/EP2006/006243, filed Jun. 28, 2006, which claims priority under 35 U.S.C. § 119 to German Patent Application No. 10 2005 030 181.9, filed Jun. 29, 2005, the disclosure of which is expressly incorporated by reference herein.

### BACKGROUND AND SUMMARY OF THE INVENTION

The invention relates to an operator control method and an associated operator control system for a vehicle.

Modern vehicles are increasingly making use of multimedia operator control systems. An example is the COMAND system in the Mercedes-Benz S class. An operator control system of this kind involves a screen display using a menu structure to display a plurality of menu levels which may include a plurality of presentation areas on the screen display. An operator controls the menu structure using manual operating means. One form of the manual operating means is known as a toggle switch arranged on a multifunction steering wheel. Operation of the toggle switch makes it possible, for example, to change between a plurality of menu items, applications, functions, sub-functions and/or options in a prescribed ring order.

One object of the present invention is to designate various applications which are used in a prescribed ring order, for example, changing between the various radio-frequency bands AM-FM-MW-LW.

In addition, the use of two toggle switches is known to allow the operator to run through the ring order of the applications in different respective directions, for example, an up or plus key or down or minus key may be provided on the multifunction steering wheel. In the case of a conventional operator control method with toggle switches, it is possible to distinguish between two cases. If, by way of example, one of the plurality of applications is active in a first case when the toggle switch is operated then it skips to the next application. If none of the applications is active in a second case then the toggle switch has no function.

The toggle switches can also be used on different menu levels. Thus, by way of example, a first toggle switch pair can be used on a first menu level to select one of a plurality of basic applications, and a second toggle switch pair can be used to select and/or set prescribed applications or parameters on a second menu level.

The prior art reveals what are known as entry switches. Following operation, these entry switches activate an application or an application group, with a stored last state or a prescribed basic state for the relevant application or application group being set. When a stored last state is set, operating the entry switch a second time allows the prescribed basic state of the relevant application and/or application group to be activated. To activate the basic state, it is also possible to prescribe a particular type of operation, for example, operation of the entry switch for a prescribed period of time.

Laid-open specification DE 199 41 947 A1 describes operator control elements for a combination instrument and a central display, where the operator control elements are integrated in a steering wheel of a motor vehicle. One of the operator control elements is in the form of a rocker switch and toggle key, with the toggle switch being used to activate and/or deactivate the combination instrument and to reset it to a basic state. A user can use the rocker switch to change between various menu presentations following activation of the combination instrument. A further operator control element is used to take an incoming telephone call or to end a telephone call which has been taken.

One object of the present invention is to provide an operator control method for a vehicle which further increases operating convenience and facilitates intuitive operator control, and to specify an associated operator control system.

This and other objects and advantages are achieved by providing an operator control method and system of the type mentioned above.

Operation of a switch is followed by establishment of an activation state for an associated application or application group. The activation state established is taken as a basis for deactivating the associated application or application group and setting a stored menu state when the associated application or application group has been activated, or for storing a current menu state and activating the associated application or application group for the purpose of operator control when the associated application or application group has been deactivated.

The inventive operator control method advantageously allows a switch to be used as an entry/exit switch which can be used to activate and deactivate the associated application or application group. The switch opens an additional or exclusive entry path and an additional or exclusive exit path from the menu. In this context, deactivation of the associated application or application group involves respectively returning to the last menu state used, from which the user entered the associated application or application group.

In one advantageous refinement of the inventive operator control method, deactivation of the associated application or application group is preceded by its current state being stored.

By way of example, the associated application or application group is in the form of a radio application, disk application, multimedia application, navigation application, video application, CD application, DVD application and/or TV application. As a further example, the associated application may also be in the form of a vehicle function, e.g. a multi-contour seat.

The associated operator control system for a vehicle for carrying out the inventive method comprises at least one switch which, when operated, activates an associated application or application group for the purpose of operator control. When activated, the stored last state or a prescribed basic state for the associated application or application group is set and is shown on a screen display. In line with the invention, the operator control system comprises an evaluation and control unit. When operation of the switch has been identified, this unit establishes an activation state for the associated application or application group. The activation state established for the associated application or application group is taken as the basis for deactivating the associated application or application group and setting a stored menu state when the associated application or application group has been activated, or for storing a current menu state and activating the associated application or application group for the purpose of operator control when the associated application or application group has been deactivated.

One refinement of the inventive operator control system provides an audio system for permanent audio output from an audio application. Another refinement of the inventive operator control system provides a vehicle function, e.g. a multi-contour seat.

An advantageous embodiment of the invention is shown in the drawings and is described below.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a block diagram of an operator control system for a vehicle.

FIGS. 2 to 4 show a flowchart for an exemplary embodiment of an inventive operator control method.

### DETAILED DESCRIPTION OF THE DRAWINGS

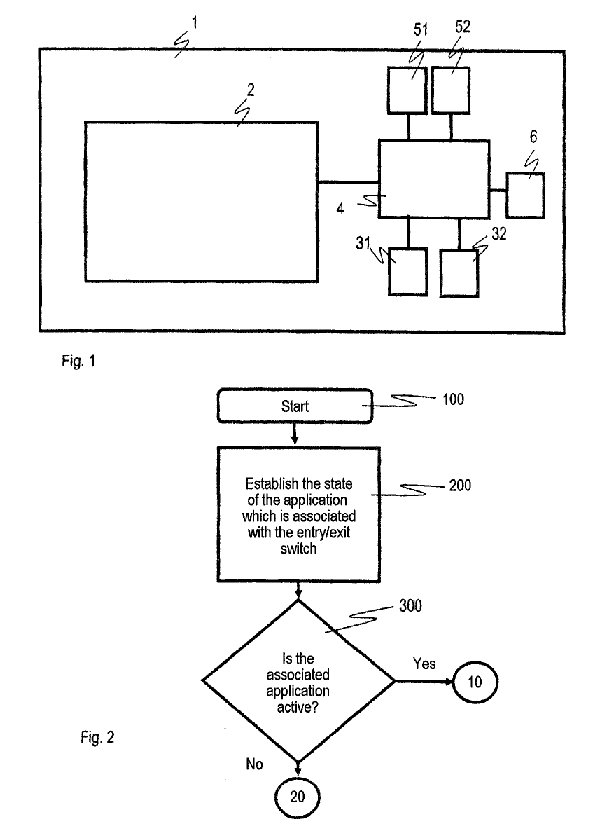

FIG. 1 shows an operator control system 1 for a vehicle with at least one screen display 2 for showing an activated application, at least one entry/exit switch 31, 32 which has an associated application 51 or an associated application group 52, the entry/exit switch 31 having the associated application 51 and the entry/exit switch 32 having the associated application group 52, an evaluation and control unit 4 which, when operation of the entry/exit switch 31, 32 has been identified, ascertains the state of the associated application 51 or application group 52 and takes the ascertained activation state as a basis for activating or deactivating the associated application 51 or application group 52, and audio system 6 for permanent audio output from an audio application.

The evaluation and control unit 4 deactivates the associated application 51 or application group 52 and sets a stored menu state when the associated application 51 or application group 52 has been activated, or stores a current menu state and activates the associated application 51 or application group 52 for the purpose of operator control when the associated application 51 or application group 52 has been deactivated.

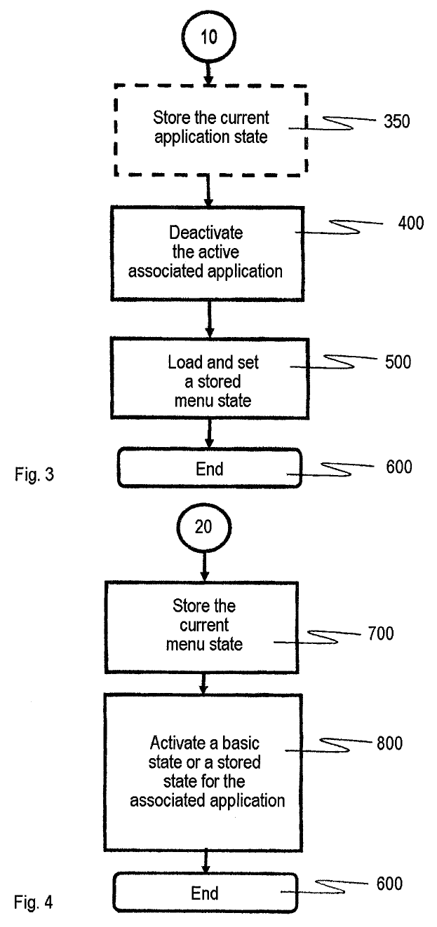

FIG. 2 describes an exemplary embodiment of the inventive operator control method for a vehicle having at least one entry/exit switch 31, 32. Operation of the entry/exit switch 31, 32 starts the method in step 100. The entry/exit switch 31, 32 can be assigned applications or application groups, the associated application also being able to be in the form of an audio application with permanent audio output via the audio system 6. Applications with a permanent audio output are, by way of example, all audio and video applications in the vehicle which comprise appropriate off states or other switched-off audio/video states, such as “no CD”. The application may also be in the form of a vehicle function, for example a multi-contour seat. In addition, an application is also understood to mean application groups, functions, sub-functions etc. which can be activated or deactivated using at least one entry/exit switch 31, 32.

A set or activated application is also understood to mean an application which had been activated not using the entry/exit switch 31, 32 but rather using a menu controller or in another way. The method described is thus an additional activation or deactivation option for the available applications in the vehicle, the various activation and deactivation types being able to be used in parallel.

As FIG. 2 reveals, identified operation of the entry/exit switch 31, 32 is followed by the inventive operator control method being started in step 100. Next, the state of the associated application 51 or of the application group 52 is established in step 200. Next, the operation branches to store the current menu state at node 20 in FIG. 4 at step 300 when the associated application 51 or application group 52 is not active.

As FIG. 4 reveals, a current menu state is stored in step 700. A basic state or a stored state for the associated application 51 or application group 52 is then activated for the purpose of operator control in step 800. Next, the method is terminated in step 600 until it is reactivated by operation of the entry/exit switch 31, 32.

If the associated application 51 or application group 52 is active, operation branches to node 10 in FIG. 3 in step 300. As FIG. 3 reveals, the currently activated application is deactivated in step 400. Before step 400, the current state of the associated active application 51 or application group 52 can be stored in step 350. In step 500, a menu state stored before the last activation of the associated application 51 or application group 52 is loaded and set. Next, the method is ended in step 600 until it is reactivated by operation of the entry/exit switch 31, 32.

The application 51 or the application group 52 comprises a variety of applications, for example, radio, disk, multimedia, navigation, video, CD, DVD and/or a TV application. It is also possible for the application to be in the form of a vehicle function, for example, a multi-contour seat. In this case, the radio application may comprise various radios, such as DAB, FM, satellite radio or alternatively the last radio band, e.g. AM, FM, MW and LW. By way of example, the disk application comprises all applications which serve a multimedia drive, such as CD audio, CD video, DVD audio, DVD video, MP3-CD etc.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-8. (canceled)

9. An operator control method for a vehicle having at least one switch which, when operated, activates an associated application or application group for operator control,
where a stored last state or a prescribed basic state for the associated application or application group is set and is shown on a screen display, characterized in that identified operation of the switch is followed by establishment of an activation state for the associated application or application group,
where the activation state established is taken as a basis for deactivating the associated application or application group and setting a stored menu state when the associated application or application group has been activated, or for storing a current menu state and activating the associated application or application group for the purpose of operator control when the associated application or application group has been deactivated.

10. The operator control method as claimed in claim 9, characterized in that deactivation of the associated application or application group is preceded by the current state being stored.

11. The operator control method as claimed in claim 9, characterized in that the associated application or application group is at least one of a radio application, a disk application, a multimedia application, a navigation application, a video application, a CD application, a DVD application, a TV application and a vehicle application.

12. The operator control method as claimed in claim 10, characterized in that the associated application or application group is at least one of a radio application, a disk application, a multimedia application, a navigation application, a video application, a CD application, a DVD application, a TV application and a vehicle application.

13. The operator control method as claimed in claim 11, characterized in that the vehicle application is a multi-contour seat.

14. The operator control method as claimed in claim 12, characterized in that the vehicle application is a multi-contour seat.

15. An operator control system for a vehicle for carrying out the method as claimed in claim 9, having:
at least one switch which, when operated, activates an associated application or application group for the purpose of operator control, where a stored last state or a prescribed basic state for the associated application or application group is set and is shown on a screen display,
characterized by an evaluation and control unit which, when operation of the switch has been identified, establishes an activation state for the associated application or application group and takes the activation state established as a basis for deactivating the associated application or application group and setting a stored menu state when the associated application or application group has been activated, or for storing a current menu state and activating the associated application or application group for the purpose of operator control when the associated application or application group has been deactivated.

16. The operator control system as claimed in claim 15, characterized by an audio system for permanent audio output from an audio application.

17. The operator control system as claimed in claim 15, characterized in that the application is a vehicle application.

18. The operator control system as claimed in claim 16, characterized in that the application is a vehicle application.

19. The operator control system as claimed in claim 17, characterized in that the vehicle application is a multi-contour seat.

20. The operator control system as claimed in claim 18, characterized in that the vehicle application is a multi-contour seat.
